(19) United States
(12) Patent Application Publication
(10) Pub. No.: US 2026/0167170 A1
(43) Pub. Date: Jun. 18, 2026

(54) Vehicle drive train with a parking lock

(71) Applicant: AUDI AG, Ingolstadt (DE)

(72) Inventor: Lukas HEIL, Adelschlag (DE)

(73) Assignee: AUDI AG, Ingolstadt (DE)

(21) Appl. No.: 19/418,622

(22) Filed: Dec. 12, 2025

(30) Foreign Application Priority Data
Dec. 13, 2024 (DE) 10 2024 137 706.2

(51) Int. Cl. B60T 17/22; B60W 10/08; B60W 10/18; B60W 50/02; F16H 63/34

(52) U.S. Cl. CPC B60T 17/221; B60W 10/08; B60W 10/182; B60W 50/0205; F16H 63/3425; B60W 2510/081; B60W 2510/085; B60W 2510/188

(57) ABSTRACT

A vehicle drive train with an electric machine (EM), which outputs power to at least one vehicle wheel, may be configured with a parking lock (PS)having a parking lock gear arranged torque-transmittingly on an output shaft of the vehicle drive train, and a locking pawl which, in a locking position, is in toothed engagement with a tooth gap among tooth gaps of the parking lock gear. The electric machine (EM) may be assigned a test unit, by which, in a training routine, a gap detection (Δt_{L}) can be carried out, such that the test unit determines a rotor rotation angle position gap (α_{L}) of the electric machine rotor corresponding to the tooth gap.

### CROSS-REFERENCE TO RELATED APPLICATIONS

This application claims the priority benefit of German Patent Application No. 10 2024 137 706.2 filed on Dec. 13, 2024, which is incorporated by reference herein in its entirety.

### BACKGROUND

### 1. Field

An invention according to described examples relates to a vehicle drive train with a parking lock and to a method for detecting at least one tooth gap of a parking lock gear of a parking lock in a vehicle drive train.

### 2. Description of the Related Art

A vehicle drive train of the type in question has an electric machine, which outputs power to at least one vehicle wheel. In addition, the vehicle drive train has a parking lock, the parking lock gear of which is arranged torque-transmittingly on an output shaft of the vehicle drive train, and the pawl of which, in a locking position, is in toothed engagement with a tooth gap of the parking lock gear.

In such a vehicle drive train with an electric drive and a form-fitting parking lock, the parking lock pawl is latched with a spring-loaded actuator into the parking lock gear when the actuated parking lock pawl slides over a bulge or tooth gap of the parking lock gear. However, the park lock controller does not know where the tooth gap is located on the parking lock gear. The tooth gaps are not symmetrically distributed either. Either the pawl directly runs into a tooth gap (in a tooth-on-tooth position), or the pawl comes into contact tooth-on-tooth with the parking lock gear. In this case, the pawl slides into the tooth gap if the vehicle rolls slightly. The pairing of the parking lock pawl with the parking lock gear is subject to mechanical wear, especially due to engagement at speeds greater than 0 km/h. Wear is determined nowadays empirically on the test bench and transmitted to an integral function on a control unit in the vehicle.

The parking lock described above has the following problem: During the engagement operation, the vehicle may roll slightly with a subsequent jolt. The actual wear or the play between the pairing of the parking lock pawl with the parking lock gear cannot be determined in the vehicle. When the parking lock is tensioned, a noticeable and audible vibration occurs in the vehicle when the parking pawl is disengaged under load.

DE 10 2018 109 465 A1 discloses a method for ascertaining a state of a parking lock of a vehicle, in which a parking pawl is automatically engaged in a form-fitting manner in, or disengaged from, a parking lock gear by a parking lock actuator. In the method, a plausibility operation is carried out in which an axial position of a motor shaft of the electric motor of the parking lock actuator can be detected for determining an additional state between a latched and an unlatched parking pawl.

DE 10 2023 202 014 B3 discloses a method for training at least one locking position of a locking actuator relative to a vehicle drive train element which is to be locked and is drivable by an electric motor. According thereto, the locked element is pivoted clockwise against the locked element as far as a first stop of the locking element and then anticlockwise against the locked element as far as a second stop of the locking element.

### SUMMARY

An example object of an invention may be to provide a vehicle drive train with a parking lock, in which the loss of comfort when engaging and disengaging the parking lock can be reduced compared to the prior art.

The example object may be achieved by the features recited in the present independent claims. Examples of refinements of the invention according to the examples may be disclosed in the dependent claims.

The invention according to the examples relates to a vehicle drive train with an electric machine, which outputs power to at least one vehicle wheel, and with a parking lock, the parking lock gear of which is arranged torque-transmittingly on an output shaft of the vehicle drive train, and the locking pawl of which, in a locking position, is in toothed engagement with a tooth gap of the parking lock gear. In an example, the following measures are taken to avoid a loss of comfort for the vehicle occupant when engaging and disengaging the parking lock: The pulse inverter of the electric machine is assigned a test unit, by which, in a training routine, a gap detection can be carried out, in which the test unit determines a rotor rotation angle position gap of the electric machine rotor corresponding to the tooth gap. The determined rotor rotation angle position gap of the electric machine rotor can be stored in a database of the test unit.

The invention according to the examples therefore relates to a test method for ascertaining the parking lock gear gaps in comparison to the rotor position and the play between the parking lock pawl and the parking lock gear. The initial determination is intended to be carried out by the end of production of the vehicle. The wear status of the parking lock can be ascertained in the workshop in front of the customer by determining the play. This ensures that the parking lock can be comfortably engaged and disengaged. Ascertaining the play and therefore the wear may prevent premature failure of the parking lock.

In a technical implementation, to start the training routine, the test unit can engage the parking lock and actuate the electric machine with a test rotational speed. With the electric machine rotating at the test rotational speed, in the case of a tooth-on-tooth position of the parking lock gear, a corresponding test current consumption of the electric machine is established. When an increase in an actual current consumption compared to the test current consumption is detected, an evaluation module of the test unit concludes that a gap has been detected. Such an increase in the actual current consumption arises as a result of a stop of the movement of the pawl against a tooth gap flank.

If such a gap is detected, an assignment module of the test unit defines an actual rotor rotation angle position, which is established at the time of the increase in the actual current consumption, as the rotor rotation angle position gap. In order to be able to carry out the process chain described above, the test unit has a measuring device for detecting the actual current consumption and a rotation angle sensor for detecting the actual rotor rotation angle position.

In an example, the training routine not only contains the detection of a gap described above, but additionally also a backlash measurement. This is carried out by the test unit after the detection of a gap has been completed. In the backlash measurement, a backlash of the locking pawl in the tooth gap is determined.

In a technical implementation, the backlash measurement comprises the following process steps, according to which
after a stop of the movement of the pawl against the tooth flank, the test unit actuates the electric machine in a counter direction of rotation at a test rotational speed,
if the actual current consumption is increased again compared to the test current consumption, the evaluation module concludes that the movement of the pawl has stopped against a counter-tooth flank, and
if there is such a stop of the movement, the assignment module defines an actual rotor rotation angle position, which arises at the time of the increase in the actual current consumption, as a counter-flank rotor rotation angle position.

For the calculation of the backlash, the test unit can have a calculation module, which calculates the backlash from a difference between the rotor rotation angle position gap and the counter-flank rotor rotation angle position, and the backlash may be able to be stored in the database.

In an example, the parking lock gear has at least two circumferentially distributed tooth gaps. In this case, after completion of the training routine carried out with respect to the first tooth gap, a follow-up training routine is carried out with respect to the second tooth gap (or further tooth gaps). In preparation for the follow-up training routine, the test unit can carry out a process chain in which the test unit firstly disengages the pawl from the first tooth gap and subsequently rotates the parking lock gear by a rotation angle offset. The follow-up training routine can then be carried out.

In an example, the parking lock gear is arranged torque-transmittingly directly on the rotor shaft. In this case, no measurement inaccuracies due to an intermediate gear backlash arise. In order to obtain satisfactory test results, in an example, the training routine is carried out in a vehicle wheel not having contact with a road surface, so that the vehicle wheel can be rotated without load during the training routine. Before the training routine is carried out, the test unit has to define a rotor rotation angle zero position in a coordinate system of the test unit, from which the actual rotor rotation angle positions are detected.

### BRIEF DESCRIPTION OF DRAWINGS

The invention according to the examples is described below on the basis of the appended figures, in which:

FIG. 1 is a diagram of a drive train for a vehicle wheel of a two-tack vehicle, according to an example;

FIG. 2 is a diagram of a parking lock gear, according to an example;

FIG. 3 is a block circuit diagram of a test unit, according to an example;

FIG. 4 is a diagram illustrating detection of a tooth gap of a parking lock gear of a parking lock of the drive train, according to an example; and

FIG. 5 is a diagram illustrating measurement of a backlash of a locking pawl in the tooth gap, according to an example.

### DESCRIPTION

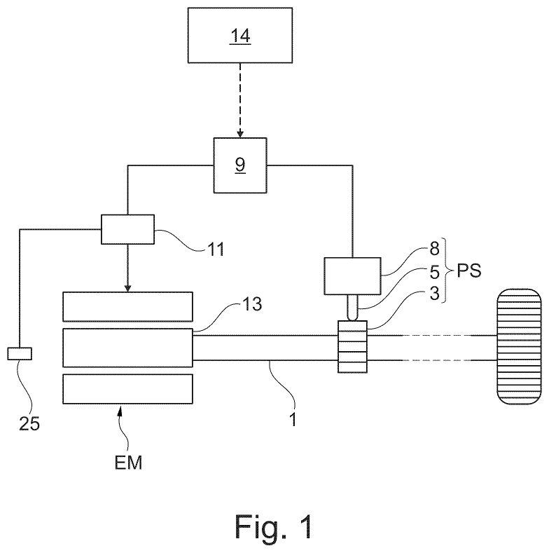

FIGS. 1 to 5 show different views, on the basis of which the method according to the examples of the invention for ascertaining the position of the tooth gaps of the parking lock gear of a parking lock are illustrated.

In FIG. 1, a drive train for a vehicle wheel of a two-tack vehicle is indicated insofar as it is necessary for the understanding of the invention according to the examples. In FIG. 1, the drive train has an electric machine (EM), the rotor shaft 1 of which is connected in terms of drive (not illustrated specifically) to the vehicle wheel. In an actual example, the rotor shaft 1 is connected in terms of drive to the two vehicle wheels of a vehicle axle of the vehicle via a countershaft stage as well as via an axle differential, for example. A parking lock PS, which has a parking lock gear 3 and an actuator-actuated pawl 5, is also installed in the drive train. The parking lock gear 3 is torque-transmittingly mounted on the rotor shaft 1. In the parking lock PS shown in FIG. 1, a regular locking operation takes place when the vehicle is stationary or is at a low vehicle speed, that is, at a low rotational speed of the parking lock gear 3. In such a locking operation, a switching shaft 7 of an actuator 8 brings the pawl 5 into contact tooth-on-tooth with the parking lock gear 3, with the intermediate connection of an overload spring, not shown. When the tooth-on-tooth contact is reached, the switching shaft 7 of the actuator 8 is further adjusted to its locked position, specifically by building up an overload spring force acting on the pawl 5. As soon as, at a small rotation angle offset, a tooth-on-gap position is produced, the pawl 5 enters into toothed engagement with one of the tooth gaps L1 to L7 of the parking lock gear 3, with the overload spring force being dissipated.

In FIG. 1, the drive train is controlled by a central control unit 9, which is in signal connection with the parking lock actuator 8 and with the pulse inverter 11 of the electric machine EM.

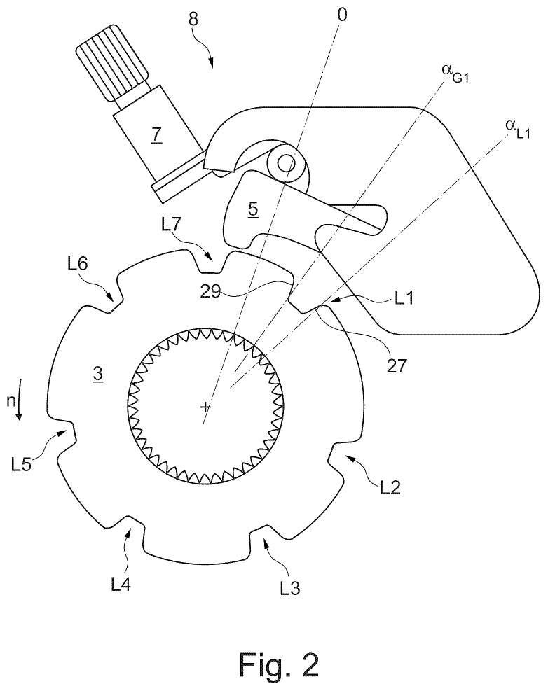

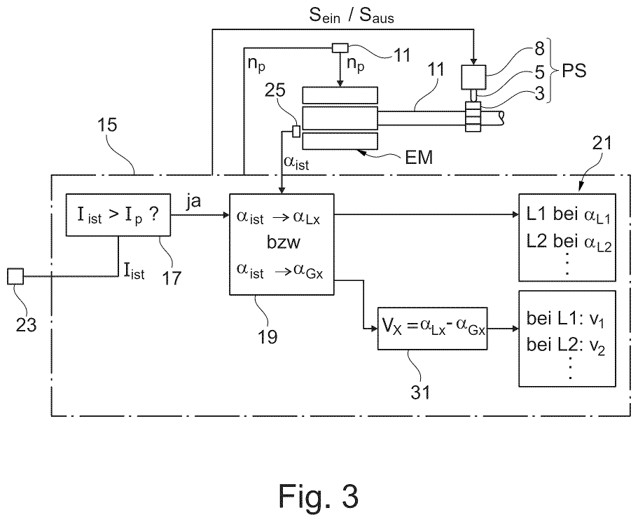

A test method for determining a rotor rotation angle position gap α₁ to α₇ of the rotor 13 of the electric machine EM corresponding to the respective tooth gap L1 to L7 is described below with reference to FIGS. 2 to 4. The test method is carried out by a tester 14 which can be applied to the central control unit 9. In addition, the test method is carried out in a vehicle wheel not having contact with a road surface, so that the vehicle wheel can rotate without load during the test method. The tester 14 is assigned a test unit 15 which may be software program modules integrated, for example, in the pulse inverter 11 and the program modules of which test unit 15 are indicated in the block circuit diagram of FIG. 3 only insofar as it is necessary for understanding the test method. Therefore, the actual software architecture of the test unit 15 and the tester 14 is not reproduced in FIG. 3.

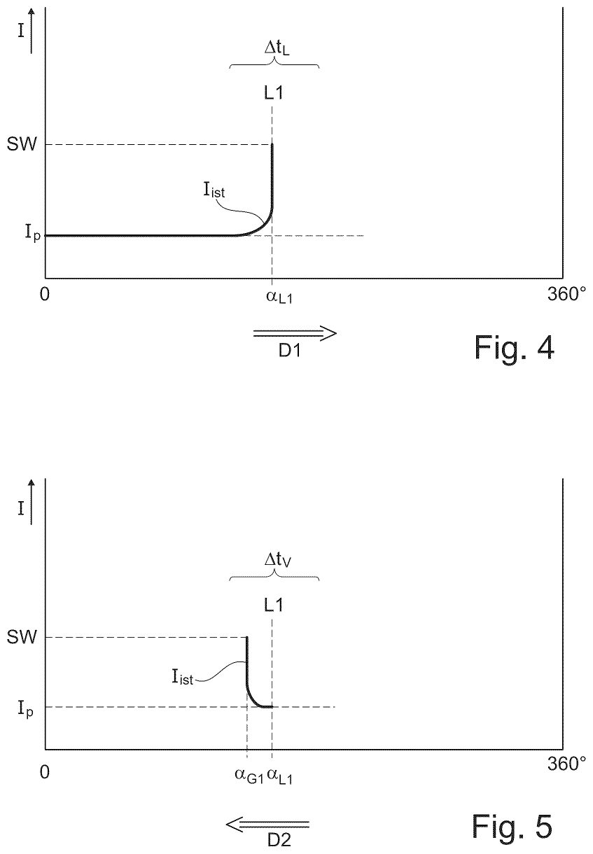

In FIG. 3, the test unit 15 has an evaluation module 17, an assignment module 19, a read-only memory or a database 21, and a calculation module 31. The evaluation module 17 is in signal connection with a measuring device 23 for measuring an actual current consumption I_{act} of the electric machine EM, while the assignment module 19 is in signal connection with a rotation angle sensor 25, which detects an actual rotor rotation angle position α_{act} of the rotor 13. By the test unit 15, a gap detection Δt_{L} (FIG. 4) can be carried out in a training routine, in which the rotor rotation angle position gap α_{L1} to α_{L7}corresponding to the respective tooth gap L1 to L7 of the electric machine rotor 13 is determined and stored in the database 21 of the test unit 15.

To start the training routine, the test unit 15 actuates the parking lock PS with a signal Sₒₙ to engage the parking lock PS. Subsequently, the test unit 15 actuates the electric machine EM at a test rotational speed n_{P.}. When the electric machine EM is operated at the test rotational speed n_{P}, in the case of a tooth-on-tooth position of the parking lock gear 3, a corresponding test current consumption I_{P} of the electric machine EM is established and is detected by the measuring device 23.

By way of example, a gap detection of the tooth gap L1 of the parking lock gear 3 is indicated in the diagram of FIG. 4. According thereto, shortly before the tooth gap L1 is reached, the measuring device 23 detects an actual current consumption I_{act}, which corresponds to the test current consumption I_{P}. During the further course, the pawl 5 latches into the tooth gap L1 and strikes against the tooth gap flank 27 (FIG. 2), as a result of which the actual current consumption I_{act} increases. As soon as the evaluation module 17 of the test unit 15 detects such a significant increase in the actual current consumption I_{act} compared to the test current consumption I_{P}, the evaluation module 17 concludes that a gap has been detected.

As soon as the tooth gap L1 is detected, the assignment module 19 defines the actual rotor rotation angle position α_{act}, which is established at the time of the increase in the actual current consumption I_{act}, as the rotor rotation angle position gap α_{L1}. The rotor rotation angle position gap α_{L1} is determined from a rotor rotation angle zero position 0 (FIG. 2). The rotor rotation angle zero position 0 is defined in a coordinate system in the test unit 15 before the training routine is carried out.

As can be seen further from the diagram of FIG. 4, when a gap is detected Δt_{L}, the actual current consumption I_{act} increases until a threshold value SW is reached. The latter forms a termination criterion at which the electric machine EM is deactivated.

After the detection of a gap Δt_{L} (FIG. 4) described above has been carried out, the test unit 15 starts a backlash measurement Δt_{V} for the tooth gap L1 (FIG. 5). In the backlash measurement Δt_{V}, a backlash v₁ of the pawl 5 in the tooth gap L1 is determined. For this purpose, the following process steps are carried out, according to which
after the stop of the movement of the pawl 5 against the tooth flank 27, the test unit 15 actuates the electric machine EM in a counter direction of rotation D2 at the test rotational speed n_{P},
if the actual current consumption I_{act} is increased again compared to the test current consumption I_{P}, the evaluation module 17 concludes that a movement of the pawl 5 has stopped against a counter-flank 29 of the tooth gap L1; and
if there is such a stop of the movement, the assignment module 19 defines an actual rotor rotation angle position α_{act}, which arises at the time of the increase in the actual current consumption I_{act}, as a counter-flank rotor rotation angle position α_{G1}, as is indicated in FIG. 5.

In a calculation module 31 of the test unit 15, the backlash v₁ is calculated from the difference between the rotor rotation angle position gap α_{L1} and the counter-flank rotor rotation angle position α_{G1} and is stored in the database 21.

Following the training routine carried out for the first tooth gap L1, the same training routine is carried out with respect to the further tooth gaps L2 to L7.

In preparation for the respective follow-up training routine, the test unit 15 actuates the parking lock PS with a disengagement signal S_{off} in order to disengage the pawl 5 from the first tooth gap L1. The test unit 15 subsequently actuates the electric machine EM to rotate the parking lock gear 3 by a rotation angle offset, whereupon the respective follow-up training routine starts.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS

3 Parking lock gear
5 Pawl
7 Switching shaft
8 Actuator
9 Central control unit
11 Pulse inverter
13 Rotor
14 Tester
15 Test unit
17 Evaluation module
19 Assignment module
21 Read-only memory
23 Current measuring device
25 Rotation angle sensor
27 Tooth flank
29 Counter-flank
31 Calculation module
I_{act} Actual current consumption
I_{P} Test current consumption
n_{P} Test rotational speed
α_{act} Actual rotor rotation angle position
α_{L} Rotor rotation angle position gap
α_{G} Counter-flank rotor rotation angle position
L1 to L7 Tooth gaps
v Backlash
Sₒₙ, S_{off} Control signals
PS Parking lock
SW Threshold value
D1, D2 Directions of rotation
0 Rotor rotation angle zero position
Δt_{L} Gap detection
Δt_{V} Backlash measurement

1. A vehicle drive train, comprising:
an electric machine configured with a rotor and an output shaft to output power to at least one vehicle wheel;
a parking lock having a parking lock gear and a pawl, the parking lock gear arranged torque-transmittingly on the output shaft of the vehicle drive train, and the pawl in a locking position being in toothed engagement with a tooth gap among tooth gaps of the parking lock gear; and
a test unit configured to be assigned to the electric machine to carry out a training routine by which detection of a gap (Δt_{L}) determines a rotor rotation angle position gap (α_{L}) of the rotor of the electric machine corresponding to the tooth gap, and store the rotor rotation angle position gap (α_{L}) in a database of the test unit.

2. The vehicle drive train according to claim 1, wherein to start the training routine, the test unit is configured to engage the parking lock and actuate the electric machine with a test rotational speed (n_{P}), at which, in case of a tooth-on-tooth position of the parking lock gear, a test current consumption (I_{P}) of the electric machine is established, and
in case of an increase in an actual current consumption (I_{act}) compared to the test current consumption (I_{P}), the test unit determines that the gap (Δt_{L}) is detected, such that the increase in the actual current consumption (I_{act}) arises as a result of a stop of a movement of the pawl against a tooth gap flank of the tooth gap.

3. The vehicle drive train according to claim 2, wherein
if the gap (Δt_{L}) is detected, the test unit defines an actual rotor rotation angle position gap (α_{act}), which is established at a time of the increase in the actual current consumption (I_{act}), as the rotor rotation angle position gap (α_{L}).

4. The vehicle drive train according to claim 3, further comprising a measuring device to detect the actual current consumption (I_{act}) and a rotation angle sensor to detect the actual rotor rotation angle position gap (α_{act}).

5. The vehicle drive train according to claim 4, wherein after the gap (Δt_{L}) has been detected, the test unit is configured to carry out a backlash measurement (Δt_{V}) to determine a backlash (v) of the pawl in the tooth gap.

6. The vehicle drive train according to claim 5, wherein to carry out the backlash measurement (Δt_{L}), the test unit is configured to
after a stop of a movement of the pawl against a tooth flank of the tooth gap, actuate the electric machine in a counter direction of rotation at a test rotational speed (n_{P}),
if the actual current consumption (I_{act}) is increased again compared to the test current consumption (I_{P )} , determine that the movement of the pawl has stopped against a counter-tooth flank of the tooth gap, and
if there is a stop of the movement, define an actual rotor rotation angle position (α_{act}), which arises at a time of the increase in the actual current consumption (I_{act}), as a counter-flank rotor rotation angle position (α_{G}).

7. The vehicle drive train according to claim 6, wherein the test unit is configured to calculate the backlash (v) from a difference between the rotor rotation angle position gap (α_{L}) and the counter-flank rotor rotation angle position (α_{G}), and to store the backlash (v) in the database.

8. The vehicle drive train according to claim 1, wherein the tooth gaps are at least two tooth gaps circumferentially distributed, and after completion of the training routine carried out with respect to a first tooth gap among the at least two tooth gaps, a follow-up training routine is carried out with respect to a second tooth gap among the at least two tooth gaps.

9. The vehicle drive train according to claim 8, wherein to carry out the follow-up training routine, the test unit is configured to disengage the pawl from the first tooth gap and rotate the parking lock gear by a rotation angle offset, whereupon the follow-up training routine is carried out.

10. The vehicle drive train according to claim 1, wherein the parking lock gear is arranged directly on the output shaft.

11. The vehicle drive train according to claim 1, wherein the test unit is configured to carry out the training routine in the at least one vehicle wheel not having contact with a road surface, so that the at least one vehicle wheel can be rotated without load.

12. The vehicle drive train according to claim 3, wherein the test unit is configured such that before the training routine is carried out, the test unit defines a rotor rotation angle zero position (0) in a coordinate system of the test unit, from which the actual rotor rotation angle position gap (α_{act}) is detected.

13. A method of detecting at least one tooth gap among the tooth gaps of the parking lock gear of the parking lock in the vehicle drive train according to claim 1.
